(19) United States
(12) Patent Application Publication
(10) Pub. No.: US 2021/0374624 A1
(43) Pub. Date: Dec. 2, 2021

(54) ELECTRONIC APPARATUS AND METHOD OF CONTROLLING THE SAME

(71) Applicant: SAMSUNG ELECTRONICS CO., LTD., Suwon-si (KR)

(72) Inventors: Youngjun KIM, Suwon-si (KR); Doheum PARK, Suwon-si (KR); Yeongtae SHIN, Suwon-si (KR); Laura KANG, Suwon-si (KR); Bokang KIM, Suwon-si (KR)

(73) Assignee: SAMSUNG ELECTRONICS CO., LTD., Suwon-si (KR)

(21) Appl. No.: 17/236,727

(22) Filed: Apr. 21, 2021

(30) Foreign Application Priority Data
May 29, 2020 (KR) 10-2020-0065250

(51) Int. Cl. G06Q 10/04; G06N 3/12; G06Q 10/06

(52) U.S. Cl. CPC G06Q 10/04; G06Q 10/0639; G06N 3/126

(57) ABSTRACT

An electronic apparatus may include an interface; and a processor configured to obtain information related to time-sequentially generated quantities of a plurality of targets via the interface, identify a group comprising at least two targets that have a relation with respect to the time-sequentially generated quantities, identify a target quantity of the identified group satisfying a predetermined prediction criterion based on a plurality of candidate target quantities of the identified group, and output information related to prediction quantities of the plurality of targets included in the identified group based on a proportion between the time-sequentially generated quantities of the plurality of targets.

### CROSS-REFERENCE TO RELATED THE APPLICATION

This application is based on and claims priority under 35 U.S.C. § 119 to Korean Patent Application No. 10-2020-0065250, filed on May 29, 2020 in the Korean Intellectual Property Office, the disclosure of which is incorporated by reference herein in its entirety.

### BACKGROUND

### 1. Field

The disclosure relates to an electronic apparatus and a control method thereof, and, more particularly, to an electronic apparatus, which predicts product quantity, and a method of controlling the same.

### 2. Description of Related Art

A company, or the like, that deals with a product often predicts a product quantity for purchase, sale, management, etc., of the product. In practice, various departments of the company are trying to maximize profits by predicting a product quantity, a sale quantity, an inventory quantity, etc., of the product according to purposes of business, and conducting the business based on the predicted quantities.

However, an increase in the number of the types of products to be dealt with causes a proportional increase in data, costs, etc., required for quantity prediction, and thus may have an adverse effect on the profits of the company, or the like. Accordingly, there is a need for a method of reducing the data, costs, etc., required for quantity prediction, especially in the situation where the number of the types of products is increased.

### SUMMARY

An aspect of the disclosure is to provide an electronic apparatus and a method of controlling the same, in which a prediction process for product quantity is efficiently designed to innovatively reduce data, costs, etc., for quantity prediction even though the types of products to be dealt with in a company, or the like, are increased. In this way, embodiments of the present disclosure may improve the utilization of computational resources for quantity prediction by reducing consumption of processor and/or memory resources for quantity prediction.

According to an aspect of the disclosure, an electronic apparatus may include an interface; and a processor configured to obtain information related to time-sequentially generated quantities of a plurality of targets via the interface, identify a group comprising at least two or more targets that have a relation with respect to the time-sequentially generated quantities, identify a target quantity of the identified group satisfying a predetermined prediction criterion based on a plurality of candidate target quantities of the identified group, and output information related to prediction quantities of the plurality of targets included in the identified group based on a proportion between the time-sequentially generated quantities of the plurality of targets.

The relation may be increasing and decreasing changes in the time-sequentially generated quantities being similar.

The relation may be a correlation between the time-sequentially generated quantities being greater than or equal to a first threshold.

The processor may obtain information related to product features corresponding to the plurality of targets; and identify the group based on the product features.

The processor may identify an amount of data corresponding to the information related to the time-sequentially generated quantities; and selectively identify the group based on the amount of data being greater than or equal to a second threshold.

The predetermined prediction criterion may relate to a genetic algorithm.

The prediction quantities of the plurality of targets may correspond to percentages of the time-sequentially generated quantities with respect to the plurality of targets.

According to an aspect of the disclosure, a method of controlling an electronic apparatus may include obtaining information related to time-sequentially generated quantities of a plurality of targets; identifying a group comprising at least two or more targets that have a relation with respect to the time-sequentially generated quantities; identifying a target quantity of the identified group satisfying a predetermined prediction criterion based on a plurality of candidate target quantities; and outputting information related to prediction quantities of the plurality of targets included in the identified group based a proportion between on the time-sequentially generated quantities of the plurality of targets.

The relation may be increasing and decreasing changes in the time-sequentially generated quantities being similar.

The relation may be a correlation between the time-sequentially generated quantities being greater than or equal to a first threshold.

The identifying the group may include obtaining information related to product features corresponding to the plurality of targets; and identifying the group based on the product features.

The identifying the group may include identifying an amount of data corresponding to the information related to the time-sequentially generated quantities; and selectively identifying the group based on the amount of data being greater than or equal to a second threshold.

The predetermined prediction criterion may relate to a genetic algorithm.

The prediction quantities of the plurality of targets may correspond to percentages of the time-sequentially generated quantities with respect to the plurality of targets.

According to an aspect of the disclosure, non-transitory computer-readable medium may store instructions that, when executed by one or more processors of an electronic apparatus, may cause the one or more processors to obtain information related to time-sequentially generated quantities of a plurality of targets; identify a group comprising at least two or more targets that have a relation with respect to the time-sequentially generated quantities; identify a target quantity of the identified group satisfying a predetermined prediction criterion based on a plurality of candidate target quantities of the identified group; and output information related to prediction quantities of the plurality of targets included in the identified group based on a proportion between the time-sequentially generated quantities of the plurality of targets.

The relation may be increasing and decreasing changes in the time-sequentially generated quantities being similar.

The relation may be a correlation between the time-sequentially generated quantities being greater than or equal to a first threshold.

The instructions may further cause the one or more processors to obtain information related to product features corresponding to the plurality of targets; and identify the group based on the product features.

The instructions may further cause the one or more processors to identify an amount of data corresponding to the information related to the time-sequentially generated quantities; and selectively identify the group based on the amount of data being greater than or equal to a second threshold.

The predetermined prediction criterion may relate to a genetic algorithm.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic apparatus according to an embodiment of the disclosure;

FIG. 2 illustrates a configuration of the electronic apparatus in FIG. 1;

FIG. 3 illustrates a configuration of a processor in FIG. 2.

FIG. 4 illustrates a method of controlling the electronic apparatus in FIG. 1;

FIG. 5 illustrates an example of identifying a group based on increasing and decreasing changes in time-sequentially generated quantities, in connection with operation S42 of FIG. 4;

FIG. 6 illustrates an example of identifying a group based on correlations between time-sequentially generated quantities, in connection with the operation S42 of FIG. 4;

FIG. 7 illustrates an example of identifying a group based on relations between features of products;

FIG. 8 illustrates a control method of selectively identifying a plurality of groups based on the amount of data, in connection with the operation S42 of FIG. 4;

FIG. 9 illustrates an example of obtaining an optimal value satisfying a genetic algorithm, in connection with the operation S43 of FIG. 4;

FIG. 10 illustrates an example of identifying prediction quantities of targets, in connection with the operation S43 of FIG. 4;

FIG. 11 illustrates another example of identifying prediction quantities of targets, based on relations between features of products, in connection with FIG. 7; and

FIG. 12 illustrates an example of obtaining information related to time-sequentially generated quantities, in connection with operation S41 of FIG. 4.

### DETAILED DESCRIPTION

Below, example embodiments of the disclosure will be described in detail with reference to accompanying drawings. In the description of the following embodiments, elements illustrated in the accompanying drawings will be referenced, and like numerals or symbols set forth in the drawings refer to like elements having substantially the same operations. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

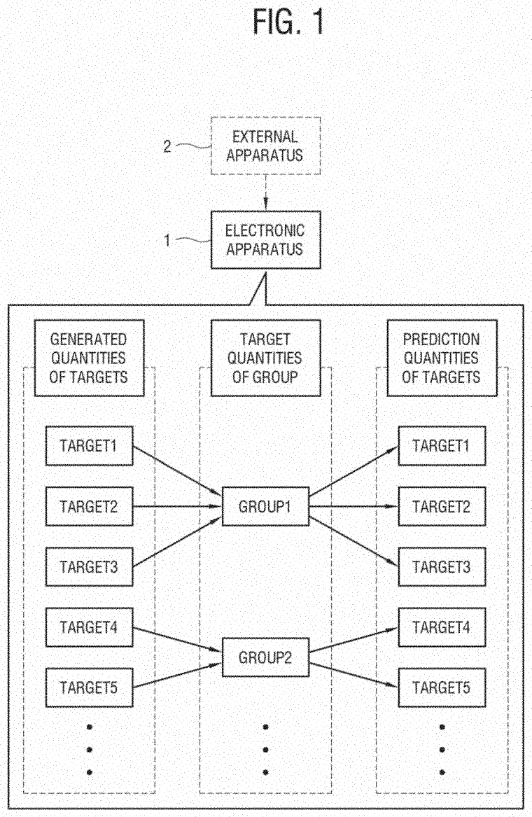

FIG. 1 illustrates an electronic apparatus according to an embodiment of the disclosure. Referring to FIG. 1, an electronic apparatus 1 may be a general-purpose computer (e.g., a personal computer (PC)), a server, etc., or may be a combination of the PC and the server. However, the electronic apparatus 1 is not limited to these examples, and may be an image displaying apparatus with a display like a television (TV), an image processing apparatus such as a set-top box with no display, a home appliance such as a refrigerator, a washing machine, etc., or the like.

The electronic apparatus 1 may obtain target information related to a target product (hereinafter referred to as a “target”). For example, the target information may include generated quantity information related to at least one of a sale quantity, a demand quantity, a supply quantity, and an inventory quantity time-sequentially generated in the past or present of the target. However, the target information is not limited to the foregoing examples, and may include profit cost information related to profit costs such as a purchasing price, a selling price, a profit margin, an inventory cost, etc., of the target, and feature information related to a name, an identification number, a size, a sort, a category, etc., of the target.

The electronic apparatus 1 may receive the target information from an external apparatus 2. The external apparatus 2 may serve as a client of the electronic apparatus 1, and may be a PC, a server, a combination of the PC and the server, etc. For example, the external apparatus 2 may be a wholesaler server, a retailer server, etc. The external apparatus 2 may receive the target information according to targets, and transmit the target information to the electronic apparatus 1 through an input supply-chain management (SCM) system. The external apparatus 2 may periodically or aperiodically transmit the target information, and the electronic apparatus 1 may update previously received target information with newly received target information. However, the target information is not limited to this example, and may be directly input to the electronic apparatus 1.

The electronic apparatus 1 may predict a quantity of a target based on the obtained target information. For example, the electronic apparatus 1 may predict at least one of the sale quantity, the demand quantity, the supply quantity, and the inventory quantity based on the generated quantity information of the target. However, the electronic apparatus 1 may predict various quantities related to the product without being limited to the foregoing examples. In a case of the inventory quantity, the electronic apparatus 1 may, for example, transmit information related to the predicted inventory quantity to the external apparatus 2, and allow the external apparatus 2 to maintain an optimal inventory quantity of the target based on the predicted inventory quantity. In other words, the external apparatus 2 orders or places an order with a supplier, a wholesaler, etc., for a target based on the predicted inventory quantity received from the electronic apparatus 1, thereby maintaining the optimal inventory quantity.

The electronic apparatus 1 according to an example embodiment may predict quantities of a plurality of targets. In this case, the electronic apparatus 1 may change a quantity prediction unit from a target unit to a group unit. As shown in FIG. 1, detailed descriptions will be made on the assumption that there are five targets (i.e., a target1 through a target5). The electronic apparatus 1 may identify a group1 including the target1 to the target3, and a groupu2 including the target4 and the target5. The electronic apparatus 1 may identify target quantities of the group1, and predict the quantities of the target1 to the target3, which belong to the group 1, based on the target quantity of the group1. Similarly, the electronic apparatus 1 may identify the target quantity of the group2, and predict the quantities of the target4 and the target5, which belong to the group2, based on the target quantity of the group2. However, the number of targets or groups may be variously designed, and is thus not limited to those shown in FIG. 1.

In this way, the electronic apparatus 1 groups a plurality of targets, thereby changing the quantity prediction unit from the target unit to the group unit. The electronic apparatus 1 can reduce the data, costs, etc., for quantity prediction by using the method of changing the quantity prediction unit. Accordingly, the electronic apparatus 1 may improve the utilization of computational resources of the electronic apparatus 1 for quantity prediction by reducing consumption of processor and/or memory resources of the electronic apparatus 1 for quantity prediction.

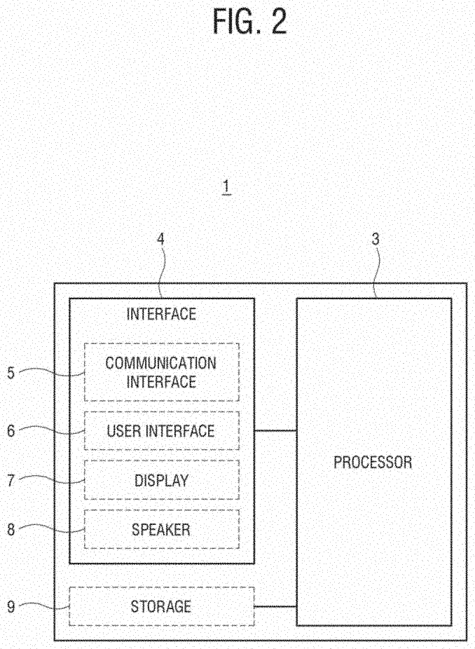

FIG. 2 illustrates a configuration of the electronic apparatus of FIG. 1. Below, the configuration of the electronic apparatus 1 will be described with reference to FIG. 2. In this example embodiment, it will be described that the electronic apparatus 1 is a PC, a server, etc. However, as described above, the electronic apparatus 1 may be various kinds of apparatuses, and this example embodiment does not limit the configuration of the electronic apparatus 1.

The electronic apparatus 1 includes an interface 4. The interface 4 includes a communication interface 5, a user interface 6, a display 7, and a speaker 8. The communication interface 5 may include a wired interface. The wired interface includes a connector, a port, etc., based on video and/or audio transmission standards such as an HDMI port, a DisplayPort, a DVI port, a thunderbolt, composite video, component video, super video, syndicat des constructeurs des appareils radiorécepteurs et téléviseurs (SCART), etc. The wired interface may include a connector, a port, etc., based on universal data transmission standards such as a universal serial bus (USB) port, etc. The wired interface may include a connector, a port, etc., to which an optical cable based on optical transmission standards is connectable. The wired interface may include a connector, a port, etc., to which an external microphone or an external audio device including a microphone is connected, and which receives or inputs an audio signal from the audio device. The wired interface may include a connector, a port, etc., to which an audio device such as a headset, an earphone, an external speaker, or the like, is connected, and which transmits or outputs an audio signal to the audio device. The wired interface may include a connector or a port based on Ethernet, or the like, network transmission standards. For example, the wired interface may be a local area network (LAN) card, or the like, connected to a router or a gateway by wire.

The wired interface may be connected to an external apparatus such as a set-top box, an optical media player, or the like, or may be connected to an external display apparatus, a speaker, a server, etc., by a cable in a manner of one to one or one to N (where N is a natural number) through the connector or the port, thereby receiving a video/audio signal from the corresponding external apparatus or transmitting a video/audio signal to the corresponding external apparatus. The wired interface may include connectors or ports to individually transmit video/audio signals. Further, the wired interface according to this example embodiment is internally provided in the electronic apparatus 1, but may also be in the form of a dongle or a module, and may be detachably connected to a connector of the electronic apparatus 1.

The communication interface 5 may include a wireless interface. The wireless interface may be a communication interface corresponding to the type of the electronic apparatus 1. For example, the wireless interface may use wireless communication based on radio frequency (RF), Zigbee, Bluetooth, Wi-Fi, ultra wideband (UWB), near field communication (NFC), etc. The wireless interface may be a wireless communication module that performs wireless communication with an access point (AP) based on Wi-Fi, a wireless communication module that performs one-to-one direct wireless communication such as Bluetooth, etc. The wireless interface may wirelessly communicate with at least one server on a network to thereby transmit and receive a data packet to and from the server. The wireless interface may include an infrared (IR) transmitter and/or an IR receiver to transmit and/or receive an IR signal based on IR communication standards. The wireless interface may receive or input a remote-control signal from a remote controller or other external devices, or transmit or output the remote-control signal to other external devices through the IR transmitter and/or IR receiver. Alternatively, the electronic apparatus 1 may transmit and receive the remote-control signal to and from the remote controller or other external devices through the wireless interface based on Wi-Fi, Bluetooth, or the like.

The electronic apparatus 1 includes a user interface 6. The user interface 6 includes circuitry related to various input interfaces provided to be controlled by a user to make a user input. The user interface 6 may be variously configured according to the type of electronic apparatus 1, and may, for example, include a mechanical or electronic button of the electronic apparatus 1, a touch pad, a touch screen installed in the display 7, etc.

The electronic apparatus 1 includes a display 7. The display 7 includes a display panel configured to display an image on a screen thereof. The display panel may have a light receiving structure like a liquid crystal display (LCD) type, or a self-emissive structure like an organic light emitting diode (OLED) type. The display 7 may include an additional element according to the structures of the display panel. For example, when the display panel is of the LCD type, the display 7 includes an LCD panel, a backlight unit for illuminating the LCD panel, and a panel driving substrate for driving liquid crystal of the LCD panel. However, the display 7 may be excluded when the electronic apparatus 1 is a set-top box, or the like.

The electronic apparatus 1 includes a speaker 8. The speaker 8 may output various sounds based on audio signals. The speaker 8 may include one or more speakers.

The interface 4 may include a microphone. The microphone collects sound, noise, etc. of surrounding environments, such as a user's utterance. The microphone transmits the collected audio signal to the processor 3.

At least one of the user interface 6, the display 7, the speaker 8, or the microphone, may be provided in the interface 4.

The electronic apparatus 1 includes a storage 9. The storage 9 is configured to store data. The storage 9 includes a nonvolatile storage in which data is retained regardless of whether power is on or off, and a volatile memory into which data to be processed by the processor 3 is loaded and in which data is retained only when power is on. The storage includes a flash memory, a hard-disc drive (HDD), a solid-state drive (SSD), a read only memory (ROM), etc., and the memory includes a buffer, a random-access memory (RAM), etc. When voice assistance is embodied by an application, or the like, the storage 9 may include the voice assistance.

The electronic apparatus 1 includes the processor 3. The processor 3 includes one or more hardware processors embodied as a central processing unit (CPU), a chipset, a buffer, a circuit, etc. which are mounted onto a printed circuit board, and may be designed as a system on chip (SoC). When the electronic apparatus 1 is embodied as a display apparatus, the processor 3 includes modules corresponding to various processes, such as a demultiplexer, a decoder, a scaler, an audio digital signal processor (DSP), an amplifier, etc. Some or all of such modules may be embodied as an SOC. For example, video processing modules such as the demultiplexer, the decoder, the scaler and the like, may be embodied as a video processing SOC, and the audio DSP may be embodied as a chipset separate from the SOC.

However, the configuration of the electronic apparatus 1 is not limited to that shown in FIG. 2, but may be designed to include less or more elements than as shown in FIG. 2. For example the electronic apparatus 1 may include a power supply, a battery, etc. The power supply may receive power from an external power source, and supply the received power as operation power to the elements. The battery may be charged with power and supply the charged power to the elements as necessary.

The processor 3 may obtain information related to time-sequentially generated quantities with regard to a plurality of targets via the interface 4, identify a plurality of groups each including two or more targets, which are related in terms of the time-sequentially generated quantity, among the plurality of targets, identify the target quantity of each group satisfying an optimal value based on a previously defined predicted criterion according to the plurality of identified groups, and perform operations of outputting information about the prediction quantities of the targets included in each group based on the identified target quantities.

The processor 3 of the electronic apparatus 1 may employ a rule-based or artificial intelligence (AI) model to perform at least one of data analysis, a process, and result-information generation for the foregoing operations. The processor 3 may apply a preprocessing procedure to data for the operations, thereby converting the data to have a proper form suitable for an input of the AI model. The AI model may be generated based on learning. Here, the generation based on the learning means that a basic AI model learns a lot of pieces of learning data by a learning algorithm so as to make a previously defined operation rule or AI model set for desired features (or purposes). The AI model may include a plurality of neural network layers. The plurality of neural network layers have a plurality of weight values, and perform a neural network operation through operations between the operation results and the previous layers and the plurality of weight values. Reasoning prediction refers to a technique for logical reasoning and predicting based on information identification, which includes knowledge based reasoning, optimization prediction, preference-based planning), recommendation, etc.

The processor 3 may perform the foregoing operations by using at least one of machine learning, a neural network, or a deep learning algorithm as the Al algorithm. For example, the processor 3 may function as both a learner and a recognizer. The learner may perform a function of generating the learned neural network, and the recognizer may perform a function of recognizing (or reasoning, predicting, estimating, and identifying) the data based on the learned neural network. The learner may generate or update the neural network. The learner may obtain learning data to generate the neural network. For example, the learner may obtain the learning data from the storage 9 or from an external source. The learning data may be data used for the learning of the neural network, and the data subjected to the foregoing operations may be used as the learning data to train the neural network.

Before training the neural network based on the learning data, the learner may perform a preprocessing operation with regard to the obtained learning data or select data to be used in learning among a plurality of pieces of the learning data. For example, the learner may process the learning data to have a preset format, apply filtering to the learning data, or process the learning data to be suitable for the learning by adding/removing noise to/from the learning data. The learner may use the preprocessed learning data for generating the neural network set to perform the operations.

The trained neural network may include a plurality of neural networks (or layers). The nodes of the plurality of neural networks have weights, and the plurality of neural networks may be connected to one another so that an output value of a certain neural network can be used as an input value of another neural network. The neural network may be a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-networks, or the like.

The recognizer may obtain target data to perform the foregoing operations. The target data may be obtained from the storage 9 or from an external source. The target data may be data targeted for recognition of the neural network. Before applying the target data to the trained neural network, the recognizer may preprocess the obtained target data or select data to be used in the recognition among a plurality of pieces of target data. For example, the recognizer may process the target data to have a preset format, apply filtering to the target data, or add/remove noise to/from the target data, thereby processing the target data into data suitable for recognition. The recognizer applies the preprocessed target data to the neural network, thereby obtaining an output value output from the neural network. The recognizer may obtain a probability value or a reliability value together with the output value.

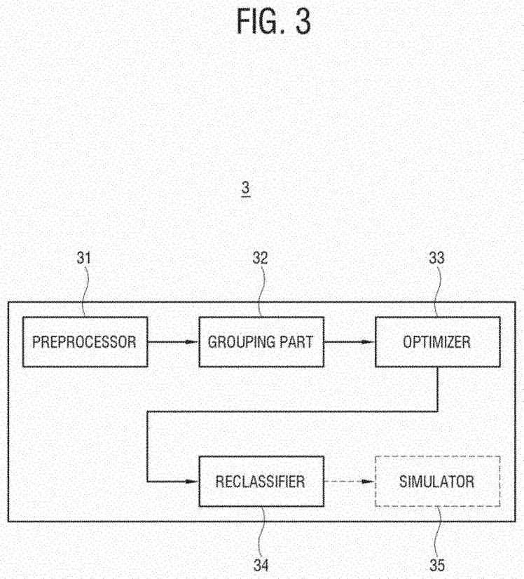

FIG. 3 illustrates a configuration of a processor in FIG. 2. The preprocessor 31 shown in FIG. 3 is a subordinate element of the processor 3, which may be embodied by at least one of hardware or software. For example, the preprocessor 31 may be embodied by a sub-processor of the processor 3, or a program running on the processor 3 or the sub-processor. Below, the elements will be described in detail with reference to FIG. 3.

The processor 3 includes the preprocessor 31. The preprocessor 31 may apply prepressing to target information obtained through the target information obtained through the interface 4. The preprocessing may include processes such as pick-up, selection, processing, estimation, prediction, etc., for the target information. For example, the preprocessor 31 may select or pick-up target information of a specific target by preprocessing the target information obtained through the interface 4, or estimate or predict data of a future section.

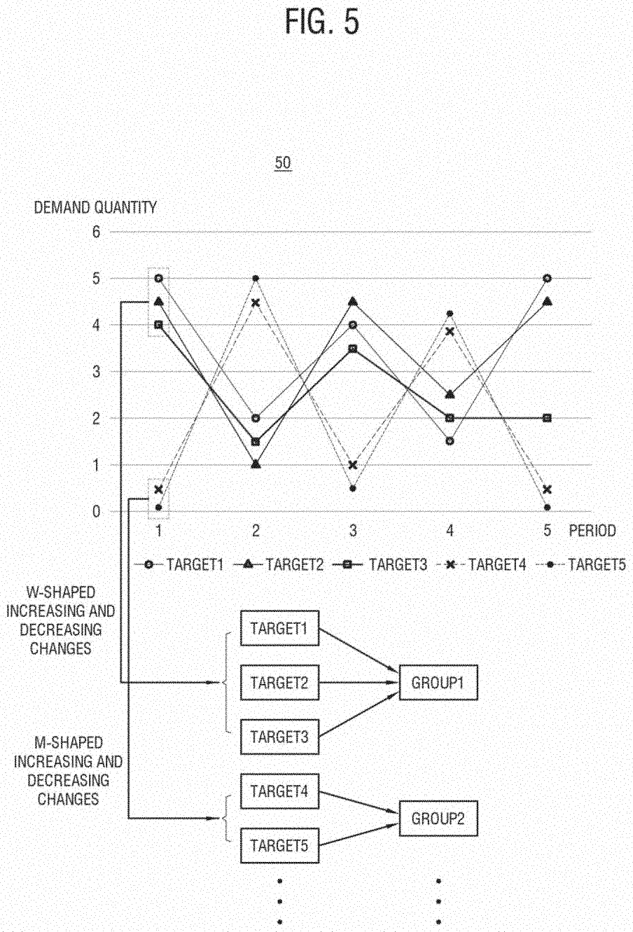

The processor 3 includes a grouping part 32. The grouping part 32 may perform grouping for identifying a group including at least two targets from among a plurality of targets based on the target information preprocessed by the preprocessor 31. For example, the grouping part 32 may group the targets which have a relation with target information. The relation may, for example, include a relation in time-sequentially generated quantity information between the targets or a relation in product feature information between the targets. In this regard, detailed descriptions will be made with reference to FIGS. 5 to 7.

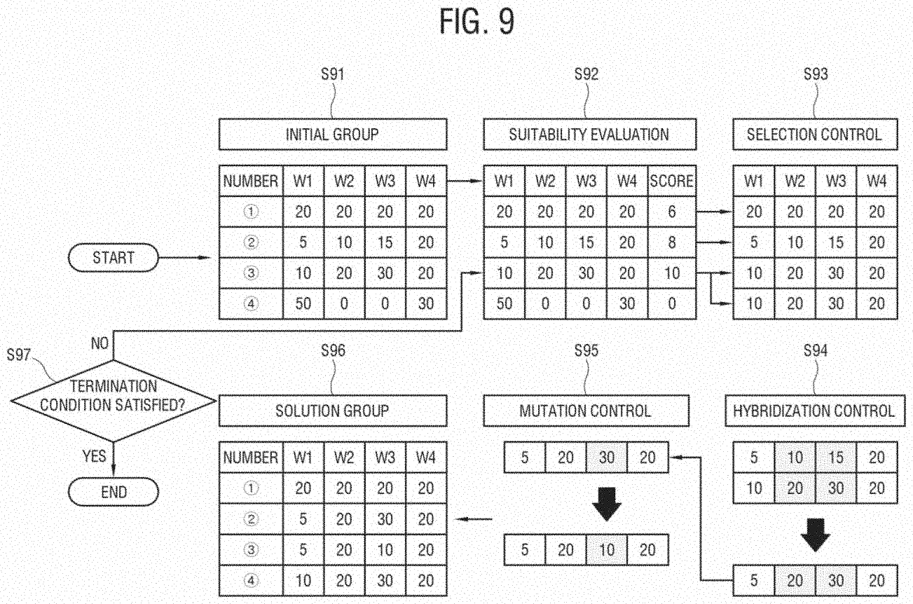

The processor 3 includes an optimizer 33. The optimizer 33 may identify each target quantity of the plurality of groups grouped by the grouping part 32. The target quantity of each group may refer to an optimal quantity level of each group or a strategy for maintaining the optimal quantity level in a production stage, a distribution stage, a selling stage, etc. The optimizer 33 may use various optimization algorithms to identify the target quantity of each group. The optimization algorithm may include, but is not limited to, a domain-heuristics algorithm, a differential weight algorithm, etc. In particular, it will be described in detail with reference to FIG. 9 that a genetic algorithm is used to identify the target quantity.

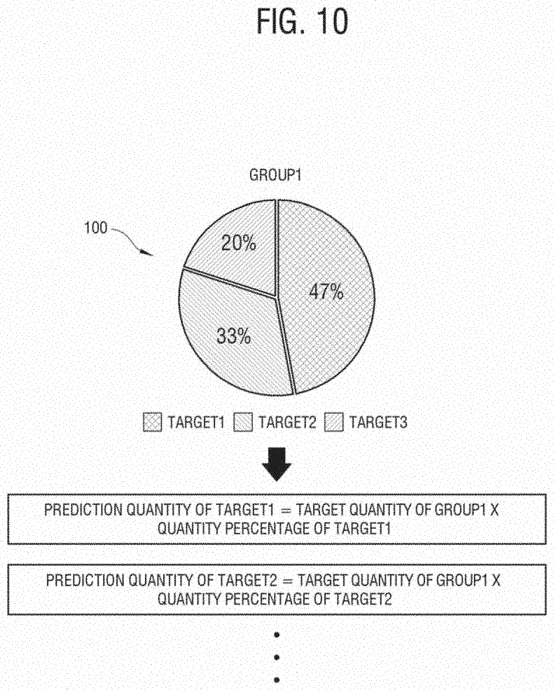

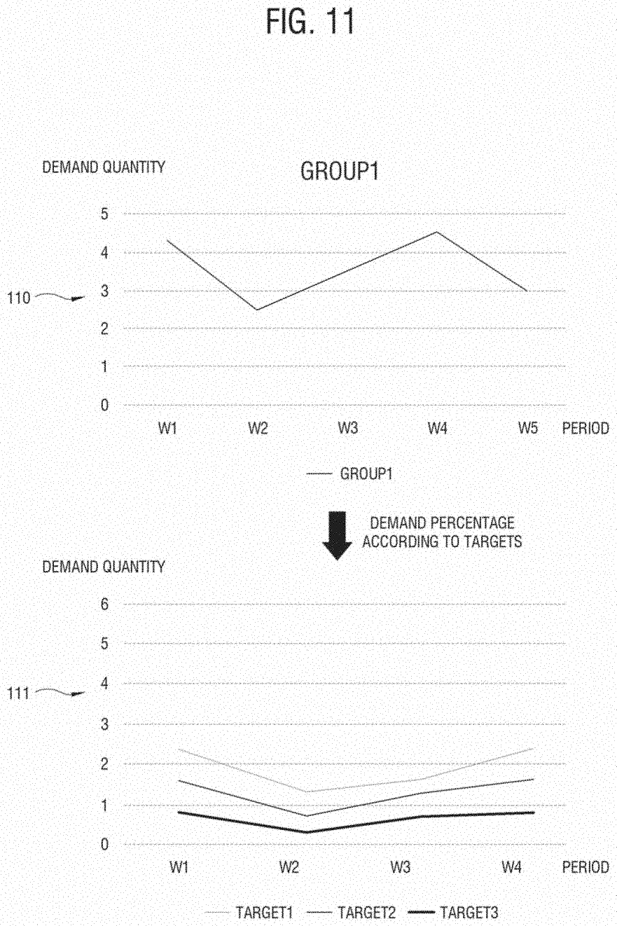

The processor 3 includes a reclassifier 34. The reclassifier 34 may predict a quantity of targets included in each group based on the target quantity of each group identified by the optimizer 33. For example, the quantity of targets may be identified in proportion to the generated quantity of targets compared to a total generated quantity of targets included in each group. In this regard, detailed descriptions will be made with reference to FIGS. 10 and 11.

The processor 3 may include a simulator 35. The simulator 35 may simulate an optimal quantity level of each group or a strategy for maintaining the optimal quantity level in a production stage, a distribution stage, a selling stage, etc., based on the prediction quantities of targets identified by the reclassifier 34. For example, when each external apparatus 2 maintains an inventory quantity based on a prediction quantity of each target, it may be simulated whether the inventory quantity is suitable for inventory management. The simulator 35 may obtain a simulation result in the form of not only data but also visuals such as a table, a graph, etc., and transmit the simulation result along with the previously identified prediction quantity of targets to the external apparatus 2.

Thus, the processor 3 regards the group as a target, and changes a prediction unit from a target unit to a group unit, thereby decreasing the data, costs, etc., required for quantity prediction.

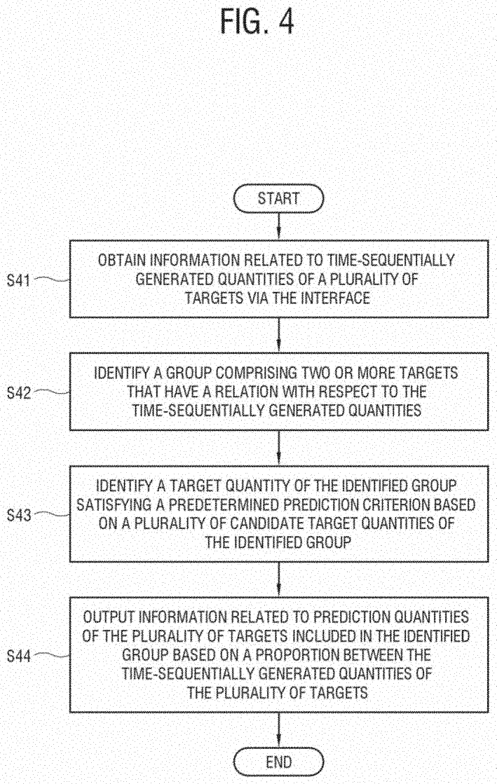

FIG. 4 illustrates a method of controlling the electronic apparatus in FIG. 1. The operations of FIG. 4 may be implemented by the processor 3 of the electronic apparatus 1. As shown in FIG. 4, the processor 3 may obtain information related to time-sequentially generated quantities of a plurality of targets via the interface 4 (operation S41), and identify a plurality of groups based on the time-sequentially generated quantities, wherein each group includes two or more targets that have a relation with respect to the time-sequentially generated quantities (operation S42).

The processor 3 may identify a plurality of target quantities corresponding to the plurality of groups, wherein each target quantity satisfies an optimal value based on a predetermined prediction criterion (operation S43), and perform an operation of outputting information related to prediction quantities of the plurality of targets included in the plurality of groups based on the plurality of target quantities (operation S44).

Thus, the processor 3 of the electronic apparatus 1 predicts the quantity of each target based on the target quantity of the group, thereby efficiently performing product management even though the number of targets for the product management increases. Accordingly, the electronic apparatus 1 may improve the utilization of computational resources of the electronic apparatus 1 for quantity prediction by reducing consumption of processor 3 and/or storage 9 resources of the electronic apparatus 1 for quantity prediction.

FIG. 5 illustrates an example of identifying a group based on increasing and decreasing changes in time-sequentially generated quantities, in connection with operation S42 of FIG. 4. As described above with reference to FIG. 1, the processor 3 may obtain time-sequentially generated information related to a plurality of targets. Below, a process of identifying increasing and decreasing changes in a demand quantity and identifying similarity between the increasing and decreasing changes will be described in detail on the assumption that a target quantity is equal to a demand quantity.

In the case of the target1, a demand quantity of ‘5’ may be generated in the first week from a specific point in the past, a demand quantity of ‘2’ may be generated in the second week, a demand quantity of ‘4’ may be generated in the third week, a demand quantity of ‘1.5’ may be generated in the fourth week, and a demand quantity of ‘5’ may be generated in the fifth week. In other words, the processor 3 can obtain information related to time-sequentially generated demand quantities of ‘5’, ‘2’, ‘4’, ‘1.5’ and ‘5’ generated in the respective weeks with respect to the target1. Similarly, the processor 3 can obtain information related to the time-sequentially generated demand quantities of the target2 to the target5 according to the respective weeks.

The processor 3 may identify two or more targets, which are related in terms of the generated demand quantities, based on the information related to the generated demand quantities of the targets, and group the two or more targets into a group. The relation may include a similarity between the increasing and decreasing changes of the generated demand quantities. Referring back to FIG. 5, the processor 3 may identify increasing and decreasing changes 50 of the demand quantities according to the targets based on the information related to the demand quantities generated in the respective weeks with respect to the target1 to the target5, and identify a similarity between the increasing and decreasing changes. For example, the processor 3 may identify that the increasing and decreasing changes of the demand quantities generated with regard to the target1 to the target3 are similar to each other because the target1 to the target3 each exhibit, for example, W-shaped increasing and decreasing changes. The processor 3 may classify the target1 to the target3 having the W-shaped increasing and decreasing changes into a group1. Similarly, the processor 3 may identify that the increasing and decreasing changes in the generated demand quantities of the target4 and the target5 are similar to each other because the target4 and the target5 each exhibit, for example, M-shaped increasing and decreasing changes, and classify the target4 and the target5 into the group2.

Thus, the processor 3 may identify a relation between the generated quantities based on a similarity between the time-sequentially generated increasing and decreasing changes in quantity with regard to the targets, thereby improving the easiness and rapidness of the grouping. Accordingly, the electronic apparatus 1 may improve the utilization of computational resources of the electronic apparatus 1 for quantity prediction by reducing consumption of processor and/or memory resources of the electronic apparatus 1 for quantity prediction.

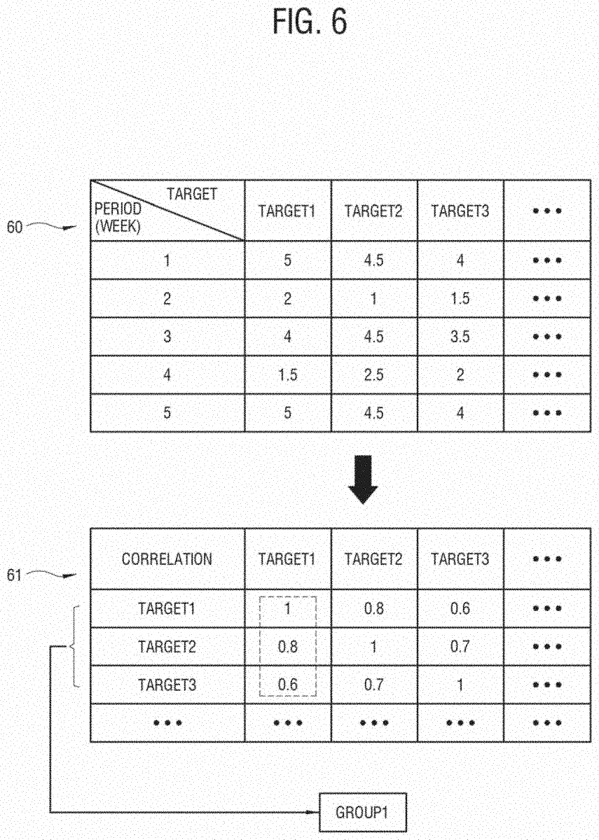

FIG. 6 illustrates an example of identifying a group based on correlations between time-sequentially generated quantities, in connection with the operation S42 of FIG. 4. The foregoing embodiment shows the example that the processor 3 identifies the relation between the generated demand quantities based on similarity between the increasing and decreasing changes of the time-sequentially generated demand quantities of the targets, but it will be described below with reference to FIG. 6 that a relation is identified based on a correlation between the time-sequentially generated demand quantities.

As shown in FIG. 6, the processor 3 may obtain information 60 related to demand quantities time-sequentially generated of the targets. The information 60 related to the generated demand quantity may, for example, include information related to demand quantities generated according to the targets in a past period (e.g., the last n weeks). The information 60 related to the generated demand quantity may be provided in the form of a look-up table, but is not limited to this example.

The processor 3 may identify a correlation between the generated demand quantities of the targets based on the information 60 related to the generated demand quantities. The correlation may be identified by calculating a correlation coefficient between pieces of generated demand quantity information 60, and the correlation coefficient may be identified by calculation methods of a Pearson correlation coefficient, a Spearman correlation coefficient, etc. The correlation is not limited to being identified based on the correlation coefficient, but may for example be identified by applying the Euclidean distance to an absolute sum or squared sum of differences in demand quantity weight according to months between the targets. Below, it will be described in detail that the correlation is identified based on the correlation coefficient.

For example, as shown in FIG. 6, the processor 3 may identify a correlation coefficient between the target1 having a generated demand quantity ‘5’ and the target2 having a generated demand quantity of ‘4.5’ in the first week, a correlation coefficient between the target1 having a generated demand quantity ‘2’ and the target2 having a generated demand quantity of ‘1’ in the second week, etc., and obtain an average of the correlation coefficients identified in the respective weeks. The processor 3 may identify the average correlation coefficient of the respective weeks as a correlation coefficient of ‘0.8’ between the generated demand quantity of the target1 and the generated demand quantity of the target2. Similarly, the processor 3 may identify a correlation coefficient of ‘0.6’ between the generated demand quantity of the target1 and the generated demand quantity of the target3, and identify correlation coefficients with the generated demand quantities of the other targets. Thus, the processor 3 identifies the correlation coefficient between the generated demand quantities of the targets, thereby obtaining information 61 related to the correlation coefficient.

The processor 3 may identify that there is a correlation between the generated demand quantities, of which the correlation coefficients are greater than or equal to a predetermined first threshold, based on correlation coefficient information 61. For example, the processor 3 may identify that there is a correlation between the generated demand quantities, of which the correlation coefficients are greater than or equal to the first threshold of ‘0.6’, thereby identifying that there is a correction among the generated demand quantity of the target1, the generated demand quantity of the target2 and the generated demand quantity of the target3, of which the correlation coefficients are greater than or equal to the first threshold of ‘0.6’. The processor 3 may group the target1 to the target3, which are identified to have a correlation between their generated demand quantities based on the correlation coefficient into the group1.

Thus, the processor 3 may identify a relation between the generated quantities based on a correlation between the generated quantities with regard to the targets, thereby improving the easiness and rapidness of the grouping, and reducing consumption of processor 3 and/or storage 9 resources of the electronic apparatus 1 for quantity prediction.

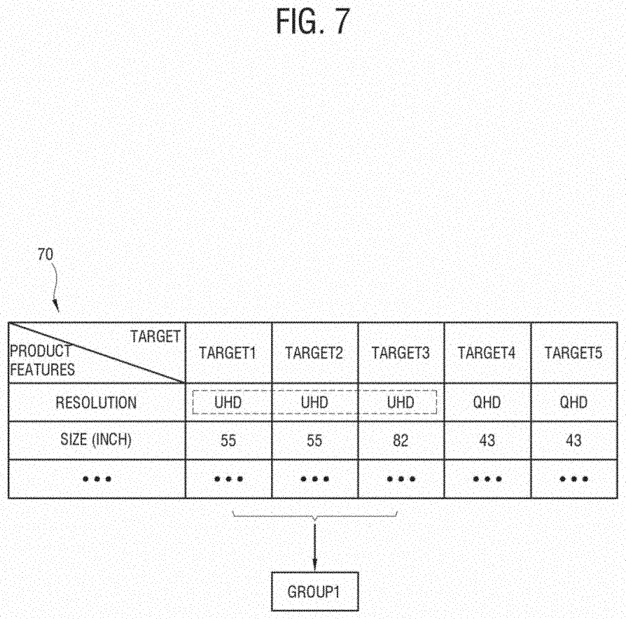

FIG. 7 illustrates an example of identifying a group based on relations between features of products. While the foregoing embodiments of FIGS. 5 and 6 show that the processor 3 identifies a relation between the targets based on the time-sequentially generated demand quantities, this embodiment will show that the processor 3 identifies whether a relation between the targets based on the features of the products.

In more detail with reference to FIG. 7, the processor 3 may obtain information 70 related to the product features of the targets. As described with reference to FIG. 1, the product feature information 70 may be received from the external apparatus 2 or may be stored when manufactured, as an example of the target information. The product feature information 70 may include information related to resolutions, screen sizes, weights, power consumption, purposes, etc., of the targets. However, the product feature information 70 may include various pieces of information related to the targets without limitation.

The processor 3 may identify the target1 to the target3, of which resolutions are for example ultra-high definition (UHD), based on the product feature information 70, and identify that there a relation among the target1 to the target3. The processor 3 may group the target1 to the target3, which are related in terms of the resolution, into the group1. Similarly, the processor 3 may identify the target4 and the target5, of which resolutions are quad-high definition (QHD), and group the target4 and the target5, which are related in terms of the resolution, into the group2. For convenience of description, one certain product feature is taken into account, but there are no limits to the product feature or the number of product features taken into account. Thus, the relation between the targets may be identified based on two or more product features. In this case, the product features may be weighted, and the weighted values may be taken into account to identify the relation between the targets.

Alternatively, the processor 3 may digitize the product features, and represent the targets with multidimensional vectors based on the digitized product features. The processor 3 may identify the relation between the targets based on comparison in distance, angle, etc., between the multidimensional vectors. The distance between the vectors may be calculated based on the Euclidean distance or another method, and the processor 3 may identify that there is a relation between the targets having the vectors between which the distance is less than or equal to a second threshold.

Thus, the processor 3 may identify a relation between the targets based on the product features of the targets, and group the targets based on the identified relation, thereby improving the easiness and rapidness of the grouping, and reducing consumption of processor 3 and/or storage 9 resources of the electronic apparatus 1 for quantity prediction.

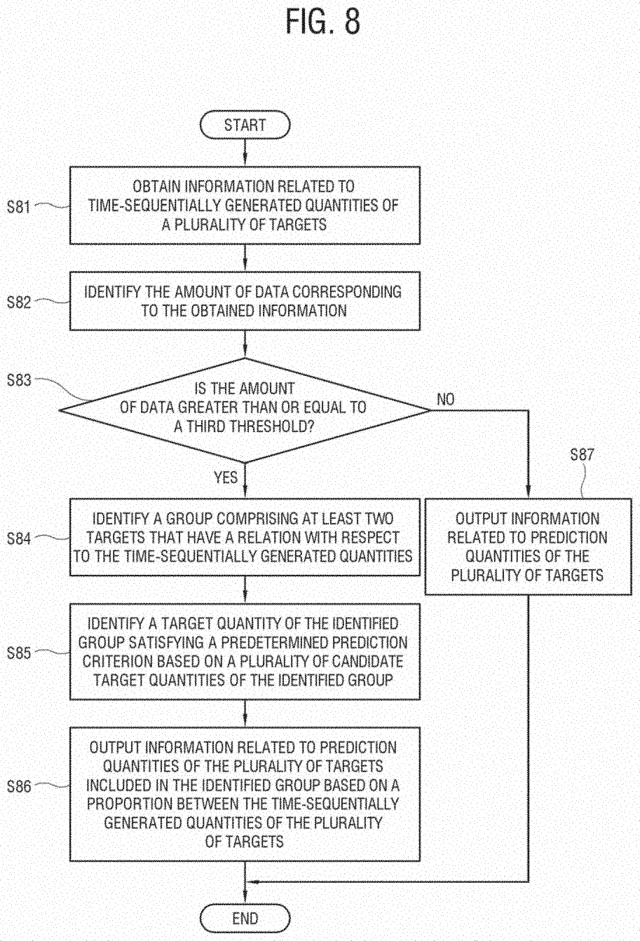

FIG. 8 illustrates a control method of selectively identifying a plurality of groups based on the amount of data, in connection with the operation S42 of FIG. 4. As shown in FIG. 8, the processor 3 obtains information related to time-sequentially generated quantities of a plurality of targets (operation S81), and identifies the amount of data corresponding to the obtained information (operation S82).

The processor 3 may identify whether the amount of data is greater than or equal to a third threshold (operation S83). The third threshold may include the amount of data previously set based on a data processing capacity of the processor 3, a data transmitting/receiving capacity of the interface 4 or a communication interface 5, a data storage capacity of the storage 9, etc. However, without limitation, the third threshold may be set based on various criteria and may be varied depending on conditions.

The processor 3 may perform operations of identify a plurality of groups based on the time-sequentially generated quantities, wherein each group includes two or more targets that have a relation with respect to the time-sequentially generated quantities, based on the amount of data corresponding to the obtained information being greater than or equal to the third threshold (operation S84), identifying a plurality of target quantities corresponding to the plurality of groups, wherein each target quantity satisfies an optimal value based on a predetermined prediction criterion (operation S85), and outputting information related to prediction quantities of the plurality of targets included in the plurality of groups based on the plurality of target quantities (operation S86). Alternatively, the processor 3 may output information related to prediction quantities of the plurality of targets, based on the amount of data being less than the third threshold (operation S87).

When the product features are taken into account as described above with reference to FIG. 7, the processor 3 obtains the product feature information 70, and two or more targets having a relation according to the product features based on the obtained information may be grouped into a plurality of groups. In this case, the processor 3 identifies the amount of data corresponding to the obtained information 70, and groups two or more targets, which have the relation based on the product features, into the plurality of groups according to whether the amount of data corresponding to the obtained information 70 is greater than or equal to the third threshold. The processor 3 may perform operations of identifying a plurality of target quantities corresponding to the plurality of groups, wherein each target quantity satisfies an optimal value based on a predetermined prediction criterion, and outputting information related to prediction quantities of the plurality of targets included in the plurality of groups based on the plurality of target quantities. Alternatively, based on the amount of data corresponding to the obtained information 70 being less than the third threshold, the processor 3 may output information related to prediction quantities of the plurality of targets.

Thus, the processor 3 of the electronic apparatus 1 may select whether the prediction is performed in units of targets or in units of groups, based on the amount of data, thereby performing active product management according to various conditions.

FIG. 9 illustrates an example of obtaining an optimal value satisfying a genetic algorithm, in connection with the operation S43 of FIG. 4. As described above with reference to FIG. 1, the processor 3 may use various optimization algorithms for each group, and identify the target quantity of each group satisfying the optimal value obtained based on the corresponding optimization algorithm. Below, it will be described in detail that the genetic algorithm is used as an example of the optimization algorithm.

As shown in FIG. 9, the processor 3 may identify a certain initial group (operation S91). The initial group may include at least one candidate target quantity set including candidate target quantities according to certain periods, such as weeks W1, W2, W3, and W4. For example, as shown in FIG. 9, a candidate target quantity sett has candidate target quantities of ‘20’, ‘20’, ‘20’ and ‘20’ corresponding to respective weeks, and a candidate target quantity set2 has candidate target quantities of ‘5’, ‘10’, ‘15’ and ‘20’ corresponding to respective weeks. Further, a candidate target quantity set3 has candidate target quantities of ‘10’, ‘20’, ‘30’ and ‘20’ corresponding to respective weeks, and a candidate target quantity set4 has candidate target quantities of ‘50’, ‘0’, ‘0’ and ‘30’ corresponding to respective weeks. The candidate target quantity may be randomly selected to provide variety.

The processor 3 may evaluate the suitability of the initial group (operation S92). The evaluation of the suitability may refer to a process of evaluating how suitable for a final solution group the candidate target quantity sets are through a predetermined suitability function. The processor 3 may give a suitability score to each candidate target quantity set through the suitability function, and identify the suitability based on whether the suitability score is greater than or equal to a fourth threshold. When the suitability score is less than the fourth threshold, the processor 3 excludes the corresponding candidate target quantity set, and evaluates suitability with regard to a reselected candidate target quantity set. In this case, the initial group includes a newly selected candidate target quantity set.

The processor 3 may perform selection control with regard to the candidate target quantities subjected to the evaluation of the suitability (operation S93). For example, the processor 3 may select the candidate target quantity set in order of suitability score from highest to lowest. However, the selection control is not limited to the foregoing method, but may include various selection control methods based on a roulette wheel, a tournament, a rank, etc.

The processor 3 may perform hybridizing control such as replacement, substitution, exchange, etc. with regard to the candidate target quantities included in the candidate target quantity sets that are different from each other (operation S94), and perform mutation control with regard to the candidate target quantities included in a certain candidate target quantity set (operation S95).

The processor 3 may use the selection control (operation S93), hybridization control (operation S93), mutation control (operation S93), and the like, to obtain a solution group showing a new population (operation S96), and identify a final solution based on whether the solution group satisfies a previously defined prediction criterion, such as a termination condition (operation S97). When the solution set does not satisfy the termination condition, the suitability evaluation (operation S92), the selection control (operation S93), the hybridization control (operation S93), the mutation control (operation S93), and the like, are performed again. Alternatively, when the solution set satisfies the termination condition, the solution set is the final solution and the target quantity is identified with the optimal value for each group.

Thus, the processor 3 of the electronic apparatus 1 may use the genetic algorithm to identify the target quantities of each group. Therefore, the solution set is collaboratively detectable by the selection control, the hybridization control, the mutation control, and the like, between the candidate target quantity sets, thereby guaranteeing an improved solution set as compared with that of simple parallel solution-set detection.

FIG. 10 illustrates an example of identifying prediction quantities of targets, in connection with the operation S43 of FIG. 4. The processor 3 may obtain percentage information 100 related to relative importance between the time-sequentially generated demand quantities of the targets included in each group. The percentage information 100 may be received from the external apparatus 2, or processed based on target information received from the external apparatus 2.

Below, it will be described with reference to FIG. 10 that the processor 3 identifies prediction demand quantities of the targets in consideration of demand quantity importance of the targets in the group1 as the percentage information 100. It will be assumed that the target1, the target2, and the target3 included in the group1 have demand quantity importance of ‘47%’, ‘33%’ and ‘20%’. However, the demand quantity importance of each target is given for convenience of description, and may be variously provided depending on demand conditions, or the like.

The processor 3 may multiply the target demand quantity of the group1 by the demand quantity importance of ‘47%’ of the target1, thereby identifying the prediction demand quantity of the target1. Similarly, the target demand quantity of the group1 may be multiplied with the demand quantity importance of ‘33%’ of the target2 or the demand quantity importance of ‘20%’ of the target3, thereby identifying the prediction demand quantity of the target2 or the prediction demand quantity of the target3.

Thus, the processor 3 of the electronic apparatus 1 may identify the prediction quantities of the targets based on arithmetic operations between the relative importance of each target and the target quantity of each group, thereby improving easiness and rapidness in identifying the prediction quantity.

FIG. 11 illustrates another example of identifying prediction quantities of targets, based on relations between features of products, in connection with FIG. 7. As shown in FIG. 11, it will be assumed that the group1 has a demand quantity of ‘4.5’ in the first week W1. However, this is merely for convenience of description, and the demand quantity may be varied depending on demand conditions or the like. When the target1 included in the group1 has demand quantity importance of ‘47%’, the target1 having a prediction demand quantity of ‘2.1’ may be identified. Likewise, when the target2 has demand quantity importance of ‘33%’ or the target3 has demand quantity importance of ‘20%’, the target2 having a prediction demand quantity of ‘1.5’ or the target3 having a prediction demand quantity of ‘0.9’ may be identified. In a similar way, when the group1 has demand quantities of ‘2.5’, ‘3.5’ and ‘4.5’ in the second week W2, the third week W3 and the fourth week W4, the target1 may have prediction demand quantities of ‘1.2’, ‘1.6’ and ‘2.1’, the target2 may have prediction demand quantities of ‘0.8’, ‘1.2’ and ‘1.5’, and the target3 may have prediction demand quantities of ‘0.5’, ‘0.7’ and ‘0.9’.

The processor 3 may transmit information 111 related to the prediction demand quantities, which are identified with regard to the target1 to the target3, to the external apparatus 2, and thus allow the external apparatus 2 to maintain the optimal inventory quantity of each target based on the prediction demand quantity.

Thus, the processor 3 of the electronic apparatus 1 may identify the prediction quantities of the targets based on arithmetic operations between the relative importance of each target and the target quantity of each group, thereby improving easiness and rapidness in identifying the prediction quantity, and reducing consumption of processor and/or memory resources of the electronic apparatus 1 for quantity prediction.

Further, when the quantities of the targets are predicted based on the relation according to the product features, it is possible to predict the quantities according to the product features, and it may be thus easier to establish the optimal quantity level according to the product features or a strategy for maintaining the optimal quantity level than the foregoing case where only the relation with the time-sequentially generated quantities is taken into account.

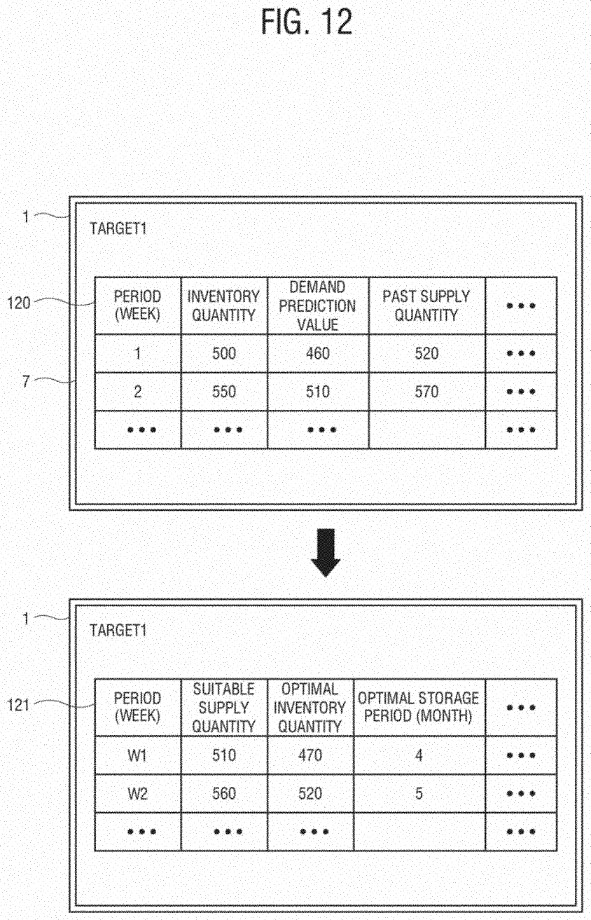

FIG. 12 illustrates an example of obtaining information related to time-sequentially generated quantities, in connection with operation S41 of FIG. 4. As described above with reference to FIG. 1, the processor 3 may obtain the target information about the targets. Below, it will be described with reference to FIG. 12 that the target information is obtained through the interface 4, and the information related to the prediction quantity is output with regard to the targets.

As shown in FIG. 12, the processor 3 may display a user interface 120 for receiving an input of the target information. The processor 3 may obtain information related to the time-sequentially generated quantity with regard to, for example, the target1 through the user interface 120. The information related to the time-sequentially generated quantities may include information related to at least one of an inventory quantity, a demand prediction value, and a past supply quantity.

As described above with reference to FIGS. 1 to 11, the processor 3 may obtain information related to time-sequentially generated quantities of a plurality of targets, identify a plurality of groups based on the time-sequentially generated quantities, wherein each group includes two or more targets that have a relation with respect to the time-sequentially generated quantities, identify a plurality of target quantities corresponding to the plurality of groups, wherein each target quantity satisfies an optimal value based on a predetermined prediction criterion, and obtain information related to prediction quantities of the plurality of targets included in the plurality of groups based on the plurality of target quantities.

The processor 3 may display information 121 related to the prediction quantity of the target1 on the display 7 as shown in FIG. 12. The information 121 related to the prediction quantity may include information related to an optimal inventory quantity, a suitable supply quantity, an optimal storage period, etc. When the information 121 related to the prediction quantity is transmitted to the external apparatus 2, the information 121 related to the prediction quantity may be displayed on the external apparatus 2.

Thus, the processor 3 of the electronic apparatus 1 may display the information 121 related to the prediction quantities of the targets, thereby allowing the optimal inventory quantity, or the like, to be intuitively checkable.

Various embodiments of the disclosure may be implemented by software including one or more commands stored in a storage medium readable and executable by the electronic apparatus 1, and the like. For example, the processor 3 of the electronic apparatus 1 may call and execute at least one command among one or more stored commands from the storage medium. This enables the electronic apparatus 1 to operate and perform at least one function based on the at least one called command. The one or more commands may include a code produced by a compiler or a code executable by an interpreter. The machine-readable storage medium may be provided in the form of a non-transitory storage medium. Here, ‘non-transitory’ refers to the storage medium being a tangible device and does not include a signal (e.g., an electromagnetic wave), and this term does not distinguish between cases of being semi-permanently and temporarily stored in the storage medium. For instance, the ‘non-transitory storage medium’ may include a buffer in which data is temporarily stored.

For example, methods according to various embodiments of the disclosure may be provided as involved in a computer program product. The computer program product according to the disclosure may include instructions of software to be executed by the processor as mentioned above. The computer program product may be traded as a product between a seller and a buyer. The computer program product may be distributed in the form of a machine-readable storage medium (e.g., a compact disc read only memory (CD-ROM)) or may be directly or online distributed (e.g., downloaded or uploaded) between two user apparatuses (e.g., smartphones) through an application store (e.g., Play Store™). In the case of the online distribution, at least part of the computer program product (e.g., a downloadable app) may be transitorily stored or temporarily produced in a machine-readable storage medium such as a memory of a manufacturer server, an application-store server, or a relay server

According to the disclosure, there are provided an electronic apparatus and a control method thereof, in which a process of predicting a product quantity is efficiently designed, thereby innovatively reducing data, costs, etc. required in quantity prediction even though the kinds of products to be dealt with in a company or the like are increased.

Although example embodiments have been shown and described, it will be appreciated by those skilled in the art that changes may be made in these embodiments without departing from the principles and spirit of the present disclosure, the scope of which is defined in the appended claims and their equivalents.

What is claimed is:

1. An electronic apparatus comprising:
an interface; and
a processor configured to:
obtain, via the interface, information related to time-sequentially generated quantities of a plurality of targets,
identify a group comprising at least two targets that have a relation with respect to the time-sequentially generated quantities,
identify a target quantity of the identified group satisfying a predetermined prediction criterion based on a plurality of candidate target quantities of the identified group, and
output information related to prediction quantities of the plurality of targets included in the identified group based on a proportion between the time-sequentially generated quantities of the plurality of targets.

2. The electronic apparatus according to claim 1, wherein the relation is increasing and decreasing changes in the time-sequentially generated quantities being similar.

3. The electronic apparatus according to claim 1, wherein the relation is a correlation between the time-sequentially generated quantities being greater than or equal to a first threshold.

4. The electronic apparatus according to claim 1, wherein the processor is further configured to:
obtain information related to product features corresponding to the plurality of targets, and
identify the group based on the product features.

5. The electronic apparatus according to claim 1, wherein the processor is further configured to:
identify an amount of data corresponding to the information related to the time-sequentially generated quantities, and
selectively identify the group based on the amount of data being greater than or equal to a second threshold.

6. The electronic apparatus according to claim 1, wherein the predetermined prediction criterion relates to a genetic algorithm.

7. The electronic apparatus according to claim 1, wherein the prediction quantities of the plurality of targets correspond to percentages of the time-sequentially generated quantities with respect to the plurality of targets.

8. A method of controlling an electronic apparatus, the method comprising:
obtaining information related to time-sequentially generated quantities of a plurality of targets;
identifying a group comprising at least two targets that have a relation with respect to the time-sequentially generated quantities;
identifying a target quantity of the identified group satisfying a predetermined prediction criterion based on a plurality of candidate target quantities; and
outputting information related to prediction quantities of the plurality of targets included in the identified group based a proportion between on the time-sequentially generated quantities of the plurality of targets.

9. The method according to claim 8, wherein the relation is increasing and decreasing changes in the time-sequentially generated quantities being similar.

10. The method according to claim 8, wherein the relation is a correlation between the time-sequentially generated quantities being greater than or equal to a first threshold.

11. The method according to claim 8, wherein the identifying the group comprises:
obtaining information related to product features corresponding to the plurality of targets; and
identifying the group based on the product features.

12. The method according to claim 8, wherein the identifying the group comprises:
identifying an amount of data corresponding to the information related to the time-sequentially generated quantities; and
selectively identifying the group based on the amount of data being greater than or equal to a second threshold.

13. The method according to claim 8, wherein the predetermined prediction criterion relates to a genetic algorithm.

14. The method according to claim 8, wherein the prediction quantities of the plurality of targets correspond to percentages of the time-sequentially generated quantities with respect to the plurality of targets.

15. A non-transitory computer-readable medium storing instructions that, when executed by one or more processors of an electronic apparatus, cause the one or more processors to:
obtain information related to time-sequentially generated quantities of a plurality of targets;
identify a group comprising at least two targets that have a relation with respect to the time-sequentially generated quantities;
identify a target quantity of the identified group satisfying a predetermined prediction criterion based on a plurality of candidate target quantities of the identified group; and
output information related to prediction quantities of the plurality of targets included in the identified group based on a proportion between the time-sequentially generated quantities of the plurality of targets.

16. The non-transitory computer-readable medium according to claim 15, wherein the relation is increasing or decreasing changes in quantity being similar.

17. The non-transitory computer-readable medium according to claim 15, wherein the relation is a correlation between the time-sequentially generated quantities being greater than or equal to a first threshold.

18. The non-transitory computer-readable medium according to claim 15, wherein the one or more instructions further cause the one or more processors to:
obtain information related to product features corresponding to the plurality of targets; and
identify the group based on the product features.

19. The non-transitory computer-readable medium according to claim 15, wherein the one or more instructions further cause the one or more processors to:
identify an amount of data corresponding to the information related to the time-sequentially generated quantities; and
selectively identify the group based on the amount of data being greater than or equal to a second threshold.

20. The non-transitory computer-readable medium according to claim 15, wherein the predetermined prediction criterion relates to a genetic algorithm.
